(19) United States
(12) Patent Application Publication
(10) Pub. No.: US 2005/0174359 A1
(43) Pub. Date: Aug. 11, 2005

(54) Image control device using color coordinates and method thereof

(75) Inventor: Byung-cheol Yu, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/052,304

(22) Filed: Feb. 8, 2005

(30) Foreign Application Priority Data
Feb. 9, 2004 (KR) 10-2004-0008477

(51) Int. Cl. G09G 5/00; G09G 5/02

(52) U.S. Cl. 345/589

(57) ABSTRACT

An image control device using color coordinates includes a measurement color storage part for storing measured color coordinates of certain images differently displayed depending on the characteristics of image realization devices; a reference color storage part for storing reference color coordinates of the certain images; and a compensation part for compensating input image signals reflecting an extent of changes between the measured color coordinates and the reference color coordinates. If input images are compensated by the device, compensated images using reference color coordinates can be at once provided.

### CROSS REFERENCE TO RELATED APPLICATION

This application claims priority from Korean Patent Application No. 10-2004-0008477 filed on Feb. 9, 2004 in the Korean Intellectual Property Office, the disclosure of which is incorporated herein by reference.

### BACKGROUND OF THE INVENTION

1. Field of the Invention

The present invention relates to an image control device and the method of controlling the image. More particularly, the present invention relates to an image control device and the method of controlling the image, using color coordinates to compensate a color reproduced from an image reproducing device for desirable colors.

2. Description of the Related Art

An image realization device reproduces a still image or a moving image by use of an electronic or machine device, and includes, for example, a television, the display of a mobile phone and the monitor of a computer. In such devices, even the same colors are differently displayed on each image display according to the varying characteristics of the image realization device. This is because of the difference of elements composing image realization devices. When the same colors are differently displayed, the original colors of inputted images are distorted. As such, various methods for displaying the inputted images in their original form have been tried.

The colors of image signals reproduced at an image realization device can be displayed as a combination of three primary colors, red R, green G and blue B.

FIG. 1A is a view of an example of color compensation according to a white balance control.

Referring to FIG. 1A, the white balance control moves the position A indicating white W to the position A′. If a color is indicated as C, the color is moved to C′ after the white balance control such that the reproduced color can be compensated. This means that the color is compensated only in apexes R, G and B without many changes on the coordinates of the three primary colors R, G and B.

Such a method, however, controls only white pattern and low grayscale white pattern with an image control point focused on white, and therefore, the color itself is not compensated.

FIG. 1B is a view of an example of a conventional color compensation device.

Referring to FIG. 1B, a compensation part 110 compensates an input image, an image realization device 120 reproduces the compensated image, and a measuring part 130 measures the reproduced image and determines if the compensated image is a reference image, and if not, feed back is made to compensate the image again.

However, such a method requires measurement and compensation of an image in order to obtain a desirable image, and thus, it is difficult to control colors immediately. For example, the compensated image is measured to determine if the compensation value is correct, and if not, the color is compensated again.

Another shortcoming is that the pattern generation device is separately provided in order to control color.

Furthermore, the prior art compensation method described above is for an analog image reproducing device, and can not be applied to an image reproducing device having a digital image processing device.

### SUMMARY OF THE INVENTION

The present invention has been developed in order to solve the above drawbacks and other problems associated with the conventional arrangement. An object of the present invention is to provide an image control device which measures color coordinates of projected images without a compensation process, determines required extents of compensation based on the stored reference color coordinates, and corrects the colors to the reference color coordinated at once, which is improved from the conventional image control device which measures the projected, compensated images and thereafter accordingly controls the white balance.

Another object of the present invention provides an image control device capable of compensating colors reproduced at an image reproducing device, without requiring separate external devices such as a pattern generation device.

Yet another object of the present invention is to provide an image control device capable of processing digital images as well as analog images.

In order to achieve the above-described aspects and/or other features of the present invention, there is provided an image control device using color coordinates, comprising a measurement color storage part for storing measured color coordinates of predetermined or certain images differently displayed depending on the particular characteristics of the image realization device; a reference color storage part for storing reference color coordinates of the certain images; and a compensation part for compensating input image signals reflecting an extent of changes from the measured color coordinates to the reference color coordinates.

The image control device may further comprise a pattern generation part or device for generating signals of the certain images, and the image realization device displays the signal images input from the pattern generation part.

The certain images may be red R, green G, blue B and white W.

The measurement color storage part may comprise a color measuring module for measuring color coordinates and brightness of images reproduced at the image realization device; a transmission module for transmitting the color coordinates and brightness to a storage module; and a storage module for storing the color coordinates and brightness.

The reference color storage part may comprise a reference color storage module for storing reference color coordinates; and a selection module for selecting one of the reference color coordinates, and the compensation part compensates input image signals reflecting the extent of changes from the measured color coordinates to the selected reference color coordinates.

The compensation part may further comprise a pattern generation part for generating signals of the certain images; and a switch for transmitting signals of the pattern generation part to the image realization device, and transmitting the input image signals to the compensation part.

In order to achieve the above-described objects and/or other features of the present invention, there is provided an image control method using color coordinates, comprising: storing reference color coordinates of certain images; measuring and storing measured color coordinates of the certain images differently displayed depending on the characteristics of the particular image realization device; and providing compensating image signals reflecting the extent of changes from the measured color coordinates to the reference color coordinates to display the compensated image signals at the image realization device.

The certain images may be red R, green G, blue B and white W.

The measuring and storing the measured color coordinates may comprise measuring and storing color coordinates and the brightness of each of red R, green G, blue B and white W.

The storing of the reference color coordinates stores reference color coordinates, and the displaying at the image realization device comprises selecting one of the reference color coordinates, providing compensating image signals reflecting the extent of changes from the measured color coordinates to the selected reference color coordinates, and displaying the compensated image signals at the image realization device.

The measuring and storing of the measured color coordinates comprises measuring color coordinates and the brightness of each of red R, green G, blue B and white W and storing color coordinates of R, G, B and W as measured color coordinates; and calculating the extent of changes from the measured color coordinates to the reference color coordinates by color coordinates and the brightness of each of the R, G, B and W.

### BRIEF DESCRIPTION OF THE DRAWINGS

The above objects and features of the present invention will be more apparent by describing certain exemplary embodiments of the present invention with reference to the accompanying drawings, in which:

FIG. 1A is a graph of an example of color controls according to a conventional white balance control,

FIG. 1B is a block diagram of an example of a conventional color compensation device,

FIG. 2 is a block diagram of an image control device using a color coordinate according to an embodiment of the present invention,

FIG. 3A is a chart of an example of measured color coordinate values and reference color coordinate values,

FIG. 3B is a graph of an example of the measured color coordinates and the reference color coordinates,

FIG. 3C is an enlarged graph of changes of the white signal indicated on FIG. 3B,

FIG. 4 is a graph of compensating image signals according to an embodiment of the present invention,

FIG. 5A is a block diagram of the image control device of FIG. 2 adding a pattern generation part, according to an embodiment of the present invention,

FIG. 5B is a block diagram of the measurement color storage part of FIG. 2, according to an embodiment of the present invention,

FIG. 5C is a block diagram of the reference color storage part of FIG. 2, according to an embodiment of the present invention,

FIG. 5D is a block diagram of an image control device of FIG. 2 according to another embodiment of the present invention, and

FIG. 6A through FIG. 6C are flow charts showing examples of image control method using color coordinates.

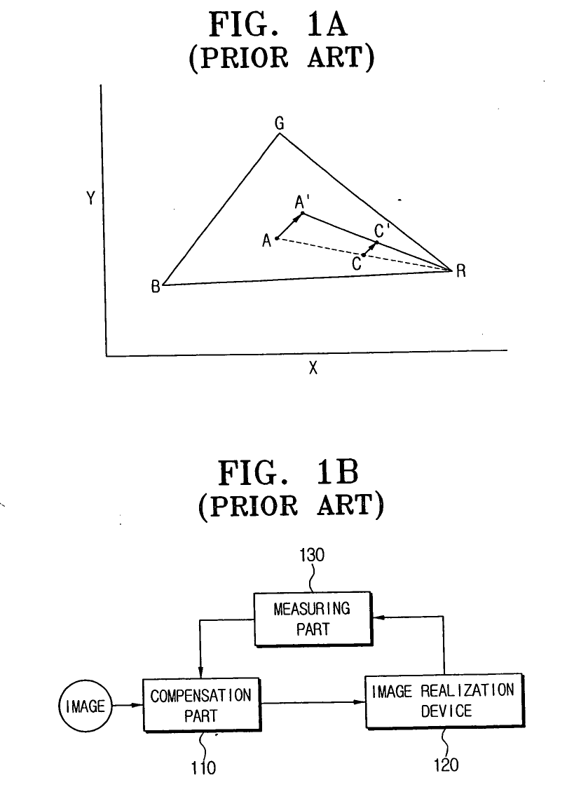

### DETAILED DESCRIPTION OF THE PREFERRED EMBODIMENTS

Certain embodiments will now be described in greater detail with reference to the accompanying drawings.

In the following description, same drawing reference numerals are used for the same elements even in different drawings. It should be understood that particular construction and elements used to describe the various embodiments are nothing but examples provided to assist in a comprehensive understanding of the invention. Thus, it is apparent that the present invention can be carried out without the particularly described construction and elements. Also, well-known functions or constructions are not described in detail since they would obscure the invention in unnecessary detail.

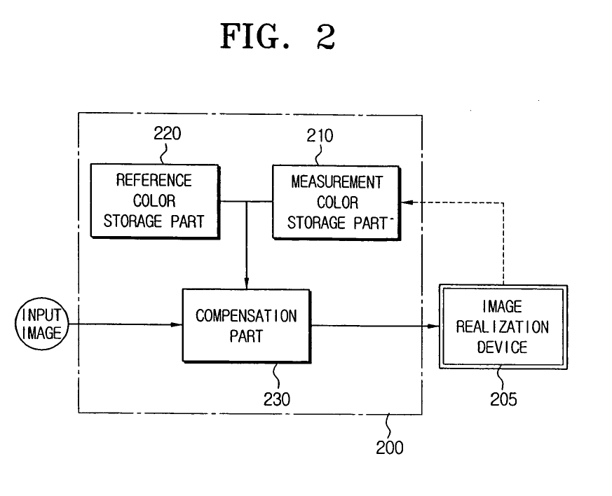

FIG. 2 is a view of an image control device using color coordinates according to an exemplary embodiment of the present invention. Referring to FIG. 2, the image control device 200 using the color coordinates according to an embodiment of the present invention comprises a measurement color storage part or device 210, a reference color storage part 220 and a compensation part 230.

The measurement color storage part 210 measures and stores color coordinates of certain images displayed differently according to the various characteristics of the particular image realization device. The reference color storage part 220 stores reference color coordinates of certain images. The compensation part 230 compensates input image signals, reflecting the extent of changes from the measured color coordinates to the reference color coordinates.

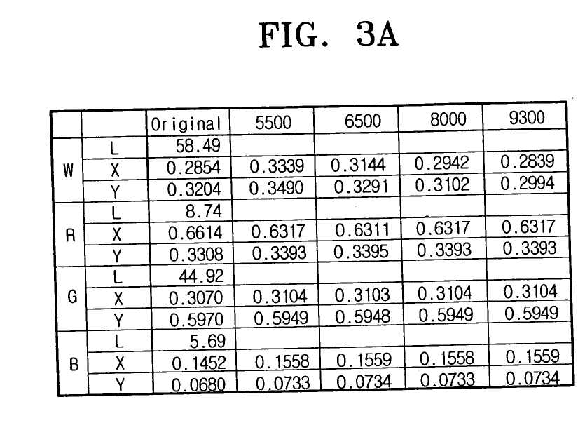

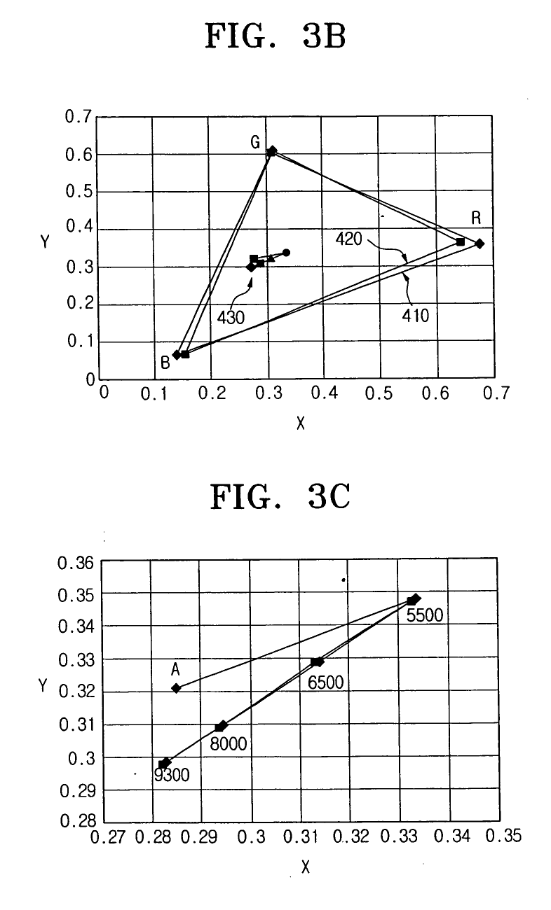

FIG. 3A is a chart showing an example of measured color coordinate values and reference color coordinate values.

Specifically, FIG. 3A is an example of measured color coordinates and reference color coordinates stored in the measurement color storage part 210 and the reference color storage part 220, respectively. The column labeled “Original” in FIG. 3A shows examples of color coordinate values of W, R, G and B of certain images stored in the measurement color storage part 210. The columns labeled 5500, 6500, 8000 and 9300 show examples of the reference color coordinates stored in the reference color storage part 220.

FIG. 3B is an example of the measured color coordinates and the reference color coordinates.

In FIG. 3B, each apex of the outside triangle 410 shows an example of color coordinates of R, G and B of the measured color coordinates. Each apex of the inside triangle 420 shows an example of color coordinates of R, G and B of the reference color coordinates. The signal 430 depicted in the triangles is color coordinates of signal W.

FIG. 3C is an enlarged view of the changes of the white signal indicated in FIG. 3B.

Specifically, FIG. 3C is an enlarged view of the white signal 430 depicted in FIG. 3B, and shows white signals at the point of color temperature of 5500K, 6500K, 8000K and 9300K. The point A shows a white signal measured from an image displayed at an image realization device.

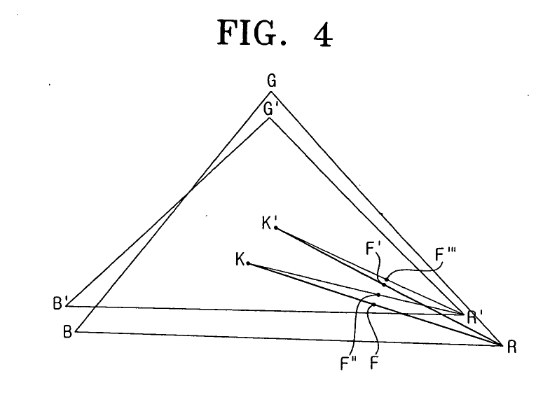

FIG. 4 is a view for explaining an image control device compensating image signals according to an exemplary embodiment of the present invention.

The compensation part 230 compensates for the input image signal, reflecting the extent of changes from the measured color coordinates to the reference color coordinates. If the white signal is changed from K to K′, a color is compensated from F to F′ according to the color compensation using a conventional white balance control method. However, if R, G and B color coordinates are changed and the white signal is also changed from K to K′, a color is changed from F to F′″ according to an embodiment of the present invention. If R, G and B color coordinates are changed and the white signal is K, a color is changed from F to F′. Any color can be differently seen in accordance with the compensation because there are differences in the extent to which the other colors are added. The difference between F′ and F″ is due to the changes of R, G and B coordinates, which are examples of the measured color coordinates depending on the characteristics of the particular image realization device, to R′, G′ and B′, which are examples of the reference color coordinates. The extent of changes from F to F′ or from F to F′″ can be obtained by calculating the extent of changes from the measured color coordinates to the reference color coordinates using color coordinates and the brightness of images, preferably, R, G, B and W, displayed on image realization devices.

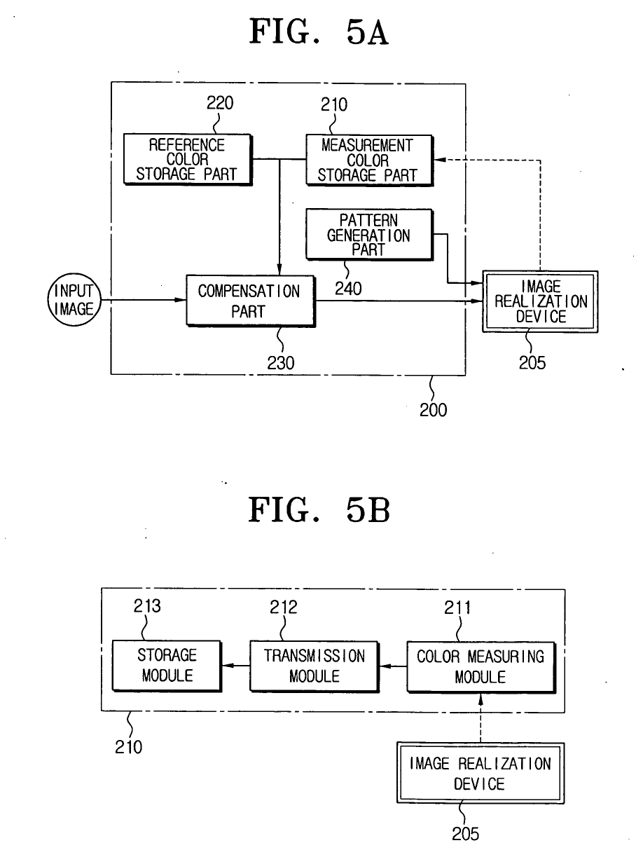

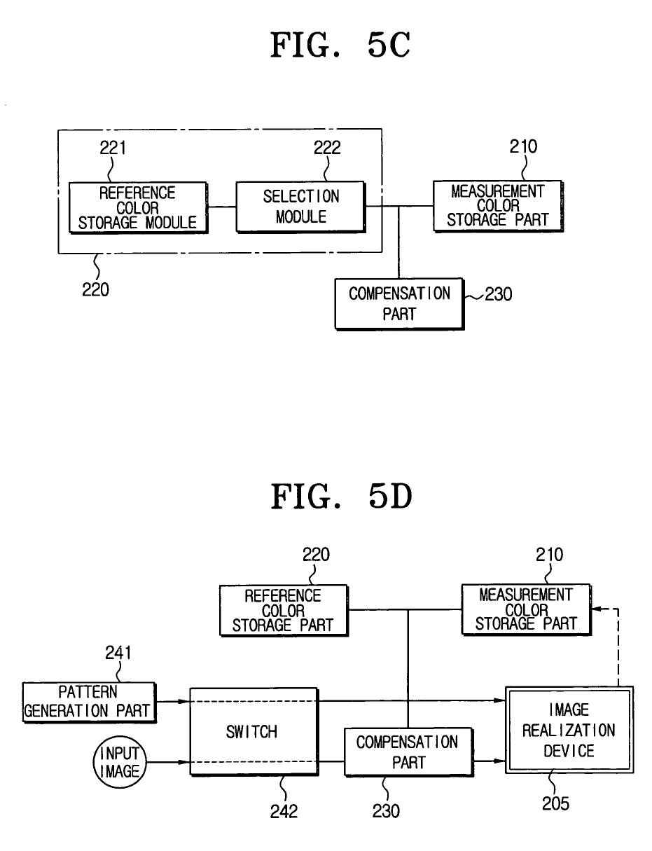

FIG. 5A shows the image control device of FIG. 2 but with the addition of a pattern generation part 240, according to an exemplary embodiment of the present invention.

The image control device 200 using the color coordinates further comprises a pattern generation part 240 for generating certain image signals, and displays images of the signal input from the pattern generation part 240. The certain images generated from the pattern generation part 240 may comprise red R, green G, blue B and white W.

FIG. 5B is a view of the measurement color storage part 210 of FIG. 2, according to an exemplary embodiment of the present invention.

The measurement color storage part 210 comprises a color measuring module 211 for measuring color coordinates and the brightness of images reproduced from the image realization device, a transmission module 212 for transmitting the color coordinates and the brightness to a storage module 213, which stores the color coordinates and brightness.

FIG. 5C is a view of the reference color storage part 220 of FIG. 2, according to an exemplary embodiment of the present invention.

The reference color storage part 220 comprises a reference color storage module 221 for storing reference color coordinates and a selection module 222 for selecting one of the reference color coordinates, and the compensation part 230 compensates for the input image signals, reflecting the extent of changes from the measured color coordinates to the selected reference color coordinates.

FIG. 5D shows an image control device of FIG. 2 according to another exemplary embodiment of the present invention.

The image control device further comprises a pattern generation part 241 for generating certain image signals and a switch 242 for transmitting the signal generated from the pattern generation part 241 to the image realization device 205 and transmitting the input image signals to the compensation part 230.

While a pattern generated from the pattern generator 240 can not be confirmed using compensated color coordinates in FIG. 5A, a pattern generated from the pattern generator 240 is input via the switch 242 of compensation unit in FIG. 5D such that the pattern as well as the input signal can be confirmed using the compensated color coordinates.

The image realization device 205 projects an image signal to display. If an image signal is generated by light, a screen is necessary, however, an image reproducing device having its own radiation elements does not need a screen, and the surface focusing the image can be considered to be a screen. Furthermore, the image realization device such as a projector may or may not have a screen.

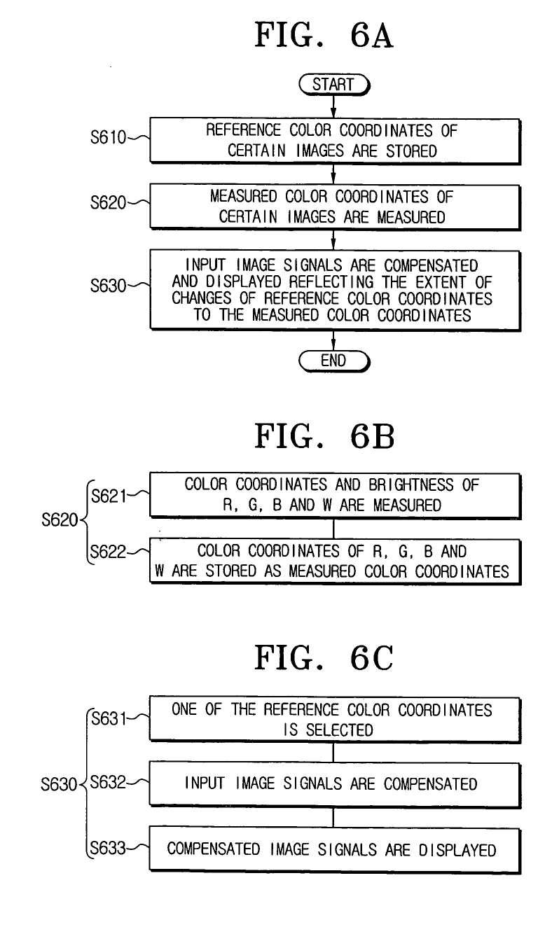

FIG. 6A through FIG. 6C are flow charts showing examples of image control method using color coordinates.

FIG. 6A is a flowchart of an example of an image control method using color coordinates. The image control method using color coordinates is described as follows.

The reference color coordinates of certain images are stored in the reference color storage part 220 (S610). The measured color coordinates of the certain images depending on the characteristic of the image realization device are measured and stored in the measurement color storage part 210 (S620). The input image signal reflecting the extent of changes from the measured color coordinates to the reference color coordinates is compensated at the compensation part 230, and the compensated signal is input to the image realization device to display (S630).

The steps of 610 and 620 may be exchanged in order. That is, step S620 may be completed before step S610.

The FIG. 6B is a flow chart showing the sub-steps of step S620 of FIG. 6A.

The certain images may comprise R, G, B and W. The step of 620 comprises measuring at the color measuring module 211 (FIG. 5B) color coordinates and the brightness of each R, G, B and W generated from the pattern generation part 240 shown in FIG. 5A (S621), and storing the measured color coordinates and brightness via the transmission module 212 into the storage module 213 (S622). Here, R, G, B and W color coordinates are the measured color coordinates.

FIG. 6C is a flow chart showing the sub-steps of step S630 of FIG. 6A.

In S610, reference color coordinates may be stored. The operation at S630 may comprise selecting at the selecting module 222 (FIG. 5C) one of the reference color coordinates (S631), compensating at the compensation part 230 the input image signal reflecting the extent of changes from the measured color coordinates to the selected reference color coordinates (S632), and displaying at the image realization device the compensated image signal (S633).

If the color coordinates and brightness of each of R, G, B and W images are measured and the color coordinates of R, G, B and W are the measured color coordinates, the extent of changes from the measured color coordinates to the reference color coordinates is calculated by use of the color coordinates and brightness of each of the measured R, G, B and W images.

As described above, according to an embodiment of the present invention, color coordinates and brightness data of certain images displayed at an image realization device are measured and compensated to the reference color coordinates such that the reference color as well as the white balance can be at once compensated. In other words, images having color signals of desirable coordinate values can be at once realized.

Furthermore, an image control device according to embodiments of the present invention has a pattern generation device therein such that all operations can be realized as one combination structure without requiring other exterior devices.

Finally, an image control device according to embodiments of the present invention can control colors to digital images as well as analog images.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. An image control device for an image realization device, comprising:
a measurement color storage unit for storing measured color coordinates of predetermined images according to the image realization device's characteristics;
a reference color storage unit for storing reference color coordinates of the predetermined images; and
a compensation unit for compensating input image signals in accordance with an extent of changes between the measured color coordinates and the reference color coordinates.

2. The image control device as claimed in claim 1, further comprising a pattern generator for generating signals of the predetermined images, and the image realization device displays signal images input from the pattern generator.

3. The image control device as claimed in claim 1, wherein the predetermined images are red R, green G, blue B and white W.

4. The image control device as claimed in claim 1, wherein the measurement color storage unit comprises:
a color measuring module for measuring color coordinates and a brightness of images reproduced by the image realization device; and
a storage module for storing the color coordinates and brightness.

5. The image control device as claimed in claim 1, further comprising a transmission module for transmitting the measured color coordinate and brightness to said storage module.

6. The image control device as claimed in claim 1, wherein the reference color storage unit comprises:
a reference color storage module for storing reference color coordinates; and
a selection module for selecting one of the reference color coordinates.

7. The image control device as claimed in claim 1, wherein the compensation unit further comprises:
a pattern generator for generating signals of the predetermined images; and
a switch operable for transmitting signals of the pattern generator to the image realization device, and operable for transmitting input image signals to the compensation unit.

8. An image control method for an image realization device, the method comprising:
storing reference color coordinates of predetermined images;
storing measured color coordinates of the predetermined images according to the image realization device's characteristics; and
compensating input image signals in accordance with an extent of changes between the measured color coordinates and the reference color coordinates to display the compensated image signals at the image realization device.

9. The method as claimed in claim 8, wherein the predetermined images are red R, green G, blue B and white W.

10. The method as claimed in claim 8, wherein the stored measured color coordinates comprises measuring and storing color coordinates and a brightness of each of red R, green G, blue B and white W.

11. The method as claimed in claim 8, wherein the stored reference color coordinates stores a plurality of reference color coordinates.

12. The method as claimed in claim 11, wherein compensating input image signals comprises:
selecting one of the stored reference color coordinates; and
compensating image signals input in accordance with an extent of changes between the measured color coordinates and the selected reference color coordinates.

13. The method as claimed in claim 12, further comprising:
displaying the compensated image signals at the image realization device.

14. The method as claimed in claim 8, wherein the storing of the measured color coordinates comprises:
measuring color coordinates and a brightness of each of red R, green G, blue B and white W and storing the measured color coordinates of R, G, B and W as measured color coordinates; and
calculating an extent of changes between the measured color coordinates and the reference color coordinates.

15. The method as claimed in claim 8, wherein the image realization device is one of a mobile phone display, a television and a computer monitor.

16. The image control device as claimed in claim 1, wherein the image realization device is one of a mobile phone display, a television and a computer monitor.
